(19) United States
(12) Patent Application Publication
(10) Pub. No.: US 2012/0193280 A1
(43) Pub. Date: Aug. 2, 2012

(54) SEPARATOR FOR SEPARATING AMALGAM

(76) Inventors: Bruno Pregenzer, Mieming (AT); Alfred Konzett, Patsch (AT)

(21) Appl. No.: 13/496,471

(22) PCT Filed: Apr. 23, 2010
(86) PCT No.: PCT/EP2010/002529

§ 371 Date: Mar. 15, 2012

(30) Foreign Application Priority Data
Jul. 31, 2009 (DE) 20 2009 010 357.9

(51) Int. Cl. B01D 29/00; B01D 29/07

(52) U.S. Cl. 210/446

(57) ABSTRACT

The present invention relates to a separator for separating amalgam from a dental waste water mixture, comprising a housing with an opening for the waste water supply and an opening for the waste water discharge and comprising a separating means arranged in the housing in a manner to be flown through for separating the amalgam from the dental waste water mixture, wherein the separating means consists of a plurality of superimposed layers of a carrier material and of lumpy material arranged between these layers.

### CROSS-REFERENCE TO RELATED APPLICATIONS

This is the U.S. National Phase of International PCT Application Serial No. PCT/EP2010/002529, entitled “Separator for Separating Amalgam”, filed Apr. 23, 2010, which claims priority to German Utility Model Application No. 20 2009 010 357.9, filed Jul. 31, 2009, which is hereby incorporated by reference in its entirety for all purposes.

Please insert the heading “TECHNICAL FIELD” before paragraph [0001].
Please insert the heading “BACKGROUND AND SUMMARY” before paragraph [0002].
Please insert the heading “BRIEF DESCRIPTION OF THE FIGURES” before paragraph [0023].
Please insert the heading “DETAILED DESCRIPTION” before paragraph [0025].
Please replace paragraphs [0022] through [0024] with the following rewritten paragraphs:

Further features, details and advantages of the invention will be explained in detail with reference to an exemplary embodiment illustrated in the drawing.

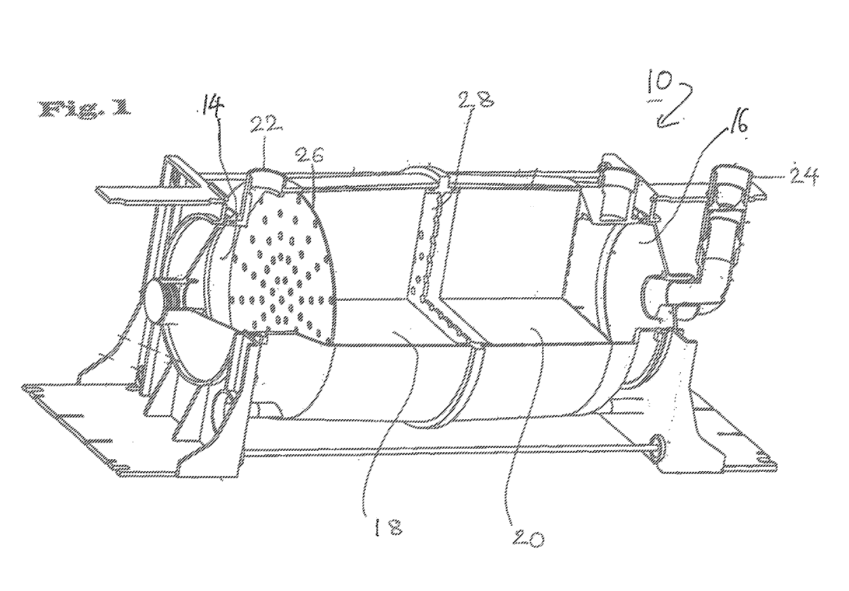

FIG. 1 shows a perspective representation of a design variant of the separator according to the present invention, partly sectioned and without inserted separating means.

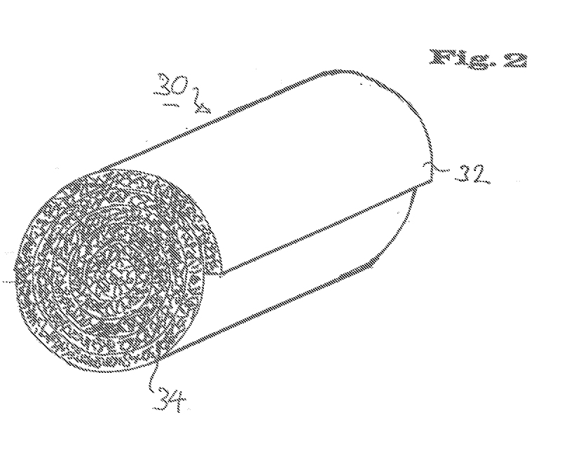

FIG. 2 shows a perspective representation of a design variant of the separating means according to the present invention.

This invention relates to a separator for separating amalgam according to the generic part of claim 1.

Amalgams and in particular dental amalgams are metal compounds of mercury, copper, zinc and silver. Due to their good physical properties in the dental field, amalgams have long since been used for making dental fillings. When removing the fillings during the dental treatment amalgam wastes are produced. The same are sucked off during the treatment together with saliva and the rinsing water and supplied to the waste water system in the dental practice. Since the amalgam residues constitute heavy metal, as explained above, the same must be separated completely before introducing the waste water into the sewer system.

For separating the amalgam particles from the dental waste water, it is known to use centrifuges. Such centrifugal separators, however, are expensive apparatuses which are comparatively costly and maintenance-intensive.

As an alternative thereto, filters are already known for separation, with which the solids to be separated are filtered out of the waste water.

Finally, sedimentation separators are also known, in which the density difference between the comparatively heavy amalgam particles and the liquid is exploited. The operating parameters in a sedimentation separator should be chosen such that the heavier particles to be separated can sink down to the sedimentation surface while flowing through the separator.

From DE 103 33 884 B4 there is known a separator for separating amalgam in the dental waste water mixture according to the generic part of claim 1, in which a housing with an opening for the waste water supply and an opening for the waste water discharge is present and in which a separating means is arranged in a housing in a manner to be flown through, in order to separate the amalgam from the dental waste water mixture. The separating means here is formed by a molded body to be flown through, which consists of a structured film lying in several layers. This structured film generally includes geometrically uniform structures, such as triangular structures, quadrangular structures or trapezoidal structures. The manufacture of such structures is comparatively expensive.

It is the object underlying the invention to provide an apparatus for the amalgam separation, in which the separating means can be manufactured in a very simple manner, wherein a good amalgam separation can be achieved with the separating means.

In accordance with the invention, this object is solved by the combination of the features of claim 1.

Accordingly, there is provided a separator for separating amalgam from a dental waste water mixture, comprising a housing with an opening for the waste water supply and an opening for the waste water discharge and comprising a separating means arranged in the housing in a manner to be flown through for separating the amalgam from the dental waste water mixture, in which the separating means consists of a plurality of superimposed layers of a carrier material and of lumpy material arranged between these layers.

Experiments have shown that by means of this separating means very easy to produce a very good separation of the amalgam particles from the dental waste water mixture becomes possible.

Preferred aspects of the invention can be taken from the sub-claims following the main claim.

Accordingly, it is advantageous that the carrier material is wound such that the lumpy material is distributed between the winding layers of the carrier material.

Advantageously, the housing includes at least one chamber for receiving the separating means.

The chamber advantageously can be circular, oval or polygonal in cross-section.

For the uniform distribution of the dental waste water mixture to be cleaned it is particularly advantageous when the at least one chamber for receiving the separating means includes distribution means each in the inlet region for the uniform distribution of the waste water mixture. This distribution means for example can be a perforated plate.

For adjusting a uniform laminar flow it is particularly advantageous when before the chamber in which the separating means is received there is also formed an inlet chamber. Quite particularly advantageously, an outlet chamber also is present in addition.

In accordance with an advantageous aspect of the invention, the carrier material consists of a flat material to be flown through, advantageously a fleece, a woven fabric, a net, a knitted fabric, a braided fabric or the like.

The lumpy material in turn advantageously consists of flakes or chips of metal, plastics and/or wood.

Particularly advantageously, the lumpy material consists of zinc chips.

The lumpy material additionally can be fixed on the carrier material by an adhesive layer.

Particularly advantageously, the entire housing is made of plastics.

Further features, details and advantages of the invention will be explained in detail with reference to an exemplary embodiment illustrated in the drawing, in which:

FIG. 1: shows a perspective representation of a design variant of the separator according to the invention, partly sectioned and without inserted separating means, and

FIG. 2: shows a perspective representation of a design variant of the separating means according to the present invention.

FIG. 1 schematically shows the separator 10. The same includes a housing 12 in which an inlet chamber 14 and an outlet chamber 16 as well as two chambers 18 and 20 for receiving the separating means not shown in detail in FIG. 1 are arranged.

Before the inlet chamber 14 the housing 12 includes an opening for the waste water supply 22 and after the outlet chamber 16 an opening for the waste water discharge 24.

Before the respective chambers for receiving the separating means 18 and 20 perforated plates 26 and 28 are inserted. The same serve to render the inflowing dental waste water mixture to be cleaned more uniform. The holes of the perforated plates 26 are chosen so large that the amalgam particles can safely penetrate through the same. The same are then separated in the separating means arranged in the chambers 18 and 20.

In FIG. 2, a separating means 30 is shown by way of example. The same consists of stacked layers of a carrier material 32 and lumpy material 34 arranged between the same. The manner in which the carrier material is superimposed in layers can be chosen as desired. In the exemplary embodiment of FIG. 2 as shown here the layers are wound. Here it is, however, also possible to stack individual layers on top of each other or to place the same on top of each other in a meandrous manner. Any other type of layering is also possible. It is essential that between the individual layers of the carrier material 32 the lumpy material is distributed as uniformly as possible.

In the illustrated exemplary embodiment as shown in FIGS. 1 and 2, the chambers 18 and 20 are cylindrically formed in the housing 12. Accordingly, the separating means are designed cylindrically, as shown in FIG. 2. The respective diameters of these separating means cylinders correspond to the inside diameter of the cylindrical chambers 18 and 20. The length of the separating means cylinders also is adapted to the length of the chambers 18 and 20.

In contrast to the exemplary embodiment shown here, another shape can of course also be chosen for the housing and the separating means, respectively. The cross-section of the housing also can be angular, for example rectangular. The separating means also might consist of layers of the carrier material stacked one above the other in a meandrous manner and of lumpy material arranged between the same. Between the individual chambers, in which the separating means are received, intermediate chambers without separating means might also be contained. As shown in FIG. 1, the housing 12 can be elongated, but it can also be horseshoe-shaped, for example, or have another shape.

The carrier material 32 basically consists of a flat material to be flown through, which advantageously is a fleece or a woven fabric, a knitted fabric, a net, a braided fabric or the like. Particularly advantageously it consists of a fleece of recycled material. The lumpy material accommodated between the layers of the carrier material 32 advantageously consists of flakes or chips of metal, plastics and/or wood. Material mixtures also can be used at any time.

The use of lumpy material of zinc chips was found to be quite particularly advantageous for reaching a particularly high degree of separation.

For the uniform distribution and fixation of the lumpy material between the carrier material it is particularly advantageous when the lumpy material is at least unilaterally fixed on the carrier material by an adhesive layer. This adhesive layer can be formed for example by a conventional spray adhesive.

In the following, a few experimental comparative tests are described:

1. Comparative test:

In the first test, a separating means with a PES fleece with a basis weight of 160 g/m² was chosen as carrier material. Zinc chips were charged on one side of the same. The carrier material was turned to form a coil corresponding to FIG. 2 and inserted into an apparatus corresponding to FIG. 1. There were two chambers, and the respective perforated plates are provided with hole diameters of 5 mm. The total length of the separating means was 2×2200 mm, and the weight of the filter material was 2×430 g. The diameter of the housing was 125 mm. The total volume of the separating vessel was 2000 ml. The length of the sedimentation distance was 200 mm. The separator was arranged horizontally. The maximum flow rate, i.e. the maximum volumetric flow rate, was 10.8 l/min. As test specimen, a 3 g copper sample was used, wherein the tests were carried out with a flow rate, i.e. a volumetric flow rate, of 5.0 l/min. The duration of the test was 2 minutes, and the rinsing time with 5 times the volume of the separation vessel, i.e. with 10 l, likewise was 2 minutes. In this test, a separation of 98.8% could be achieved.

2. Comparative test:

Here, substantially the same set-up was chosen as in the first comparative test. In particular, the separating means was configured in the same way. In contrast to the preceding example, the volume of the separation vessel here is smaller. It is merely 800 ml. The maximum flow rate is 7.3 l/min. Due to the smaller dimension, the volumetric flow rate also is reduced to 1.0 l/min. The duration of the test here was 2 minutes, while the rinsing time with 5 times the rinsing volume of the separation vessel, i.e. 4 liters, was 4 minutes. With this configuration, a degree of separation of 98.6% could be achieved.

1. A separator for separating amalgam from a dental waste water mixture, comprising a housing with an opening for the waste water supply and an opening for the waste water discharge, and comprising a separating means arranged in the housing in a manner to be flown through for separating the amalgam from the dental waste water mixture,
wherein the separating means includes a plurality of superimposed layers of a carrier material and of lumpy material arranged between the same.

2. The separator according to claim 1, wherein the carrier material is wound such that the lumpy material is distributed between the winding layers of the carrier material.

3. The separator according to claim 1, wherein the housing includes at least one chamber for receiving the separating means.

4. The separator according to claim 3, wherein the chamber is circular, oval or polygonal in cross-section.

5. The separator according to claim 3, wherein the at least one chamber for receiving the separating means each includes distributing means in the inlet for uniformly distributing the waste water mixture.

6. The separator according to claim 5, wherein the distributing means each is a perforated plate.

7. The separator according to claim 3, wherein there is each provided an inlet chamber and/or an outlet chamber.

8. The separator according to claim 7, wherein the carrier material consists of a flat material to be flown through, advantageously of a fleece, a woven fabric or the like.

9. The separator according to claim 8, the lumpy material consists of flakes or chips of metal, plastics and/or wood.

10. The separator according to claim 9, wherein the lumpy material consists of zinc chips.

11. The separator according to claim 8, wherein the lumpy material is fixed on the carrier material by an adhesive layer.

12. The separator according to claim 1, wherein the housing is made of plastics.
